(19) United States
(12) Patent Application Publication
(10) Pub. No.: US 2026/0148746 A1
(43) Pub. Date: May 28, 2026

(54) METHOD AND APPARATUS FOR GRADUAL SPEECH ENHANCEMENT AND RESTORATION: LEVERAGING CODEC MODULES FOR IMPROVED DE-NOISING AND DEREVERBERATION

(71) Applicant: TENCENT AMERICA LLC, Palo Alto, CA (US)

(72) Inventors: Hao ZHANG, Palo Alto, CA (US); Yong XU, Pala Alto, CA (US); Meng YU, Palo Alto, CA (US); Dong YU, Palo Alto, CA (US)

(73) Assignee: TENCENT AMERICA LLC, Palo Alto, CA (US)

(21) Appl. No.: 18/961,777

(22) Filed: Nov. 27, 2024

(51) Int. Cl. G10L 19/035; G10L 19/038; G10L 25/18; G10L 25/30

(52) U.S. Cl. CPC G10L 19/035; G10L 19/038; G10L 25/18; G10L 25/30

(57) ABSTRACT

A method includes inputting a mixture signal comprising speech, background noise, and reverberation into a denoising stage that generates a denoised mixture signal with reduced noise compared to the mixture signal; fusing the denoised mixture signal with the mixture signal to generate a fused signal; and inputting the fused signal into a dereverberation and restoration (DR) stage to generate an output signal with reduced reverberation compared to the mixture signal.

### FIELD

The disclosure generally relates to the field of audio signal processing, specifically to methods and systems for speech enhancement and dereverberation.

### BACKGROUND

Speech enhancement (SE) is essential for improving listening experiences and enhancing the performance of various speech processing applications, such as automatic speech recognition systems, telecommunications, and hearing assistance devices. In real-world environments, factors like environmental noise and room reverberation can severely degrade the quality of speech, making robust SE methods crucial for effective communication.

SE is typically framed as a supervised learning problem, with approaches broadly divided into time-frequency (T-F) domain and time-domain methods. In the T-F domain, speech signals are transformed into a T-F representation using techniques such as the short-time Fourier transform (STFT). In this domain, enhancement targets include masking-based approaches, such as the ideal binary mask (IBM), ideal ratio mask (IRM), and complex ratio mask (CRM), as well as mapping-based techniques that directly estimate the spectral representation of clean speech. Alternatively, time-domain methods aim to estimate clean speech directly from the raw waveform. However, these methods may often introduce unwanted distortions in the speech signal.

Recently, there has been growing interest in leveraging generative models for SE. These models, including generative adversarial networks (GANs), variational autoencoders (VAEs), flow-based models, and diffusion probabilistic models, have demonstrated superior capabilities in handling noise and generalizing across various scenarios. However, under adverse conditions, these generative models can sometimes confuse phonemes, leading to the generation of unintended vocal artifacts.

However, a need remains for methods that can address both noise and reverberation while minimizing distortions. Existing approaches often struggle with these combined challenges, leading to degraded speech quality in practical applications.

### SUMMARY

According to an aspect of the disclosure, a method performed by at least one processor includes inputting a mixture signal comprising speech, background noise, and reverberation into a denoising stage that generates a denoised mixture signal with reduced noise compared to the mixture signal; fusing the denoised mixture signal with the mixture signal to generate a fused signal; and inputting the fused signal into a dereverberation and restoration (DR) stage to generate an output signal with reduced reverberation compared to the mixture signal.

According to an aspect of the disclosure, an apparatus includes: at least one memory configured to store program code; and at least one processor configured to read the program code and operate as instructed by the program code, the program code including: first inputting code configured to cause the at least one processor to input a mixture signal comprising speech, background noise, and reverberation into a denoising stage that generates a denoised mixture signal with reduced noise compared to the mixture signal; fusing code configured to cause the at least one processor to fuse the denoised mixture signal with the mixture signal to generate a fused signal; and second inputting code configured to cause the at least one processor to input the fused signal into a dereverberation and restoration (DR) stage to generate an output signal with reduced reverberation compared to the mixture signal.

According to an aspect of the disclosure, a non-transitory computer readable medium having instructions stored therein, which when executed by a processor cause the processor to execute a method including inputting a mixture signal comprising speech, background noise, and reverberation into a denoising stage that generates a denoised mixture signal with reduced noise compared to the mixture signal; fusing the denoised mixture signal with the mixture signal to generate a fused signal; and inputting the fused signal into a dereverberation and restoration (DR) stage to generate an output signal with reduced reverberation compared to the mixture signal.

### BRIEF DESCRIPTION OF THE DRAWINGS

Further features, the nature, and various advantages of the disclosed subject matter will be more apparent from the following detailed description and the accompanying drawings in which:

FIG. 1 is a diagram of an environment in which methods, apparatuses, and systems described herein may be implemented, according to embodiments.

FIG. 2 is a block diagram of example components of one or more devices of FIG. 1.

FIG. 3 is a block diagram of an example restorative speech enhancement architecture, according to embodiments.

FIG. 4 is a flowchart of an example restorative speech enhancement process, according to embodiments.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Reference throughout this specification to “one embodiment,” “an embodiment,” or similar language means that a particular feature, structure, or characteristic described in connection with the indicated embodiment is included in at least one embodiment of the present solution. Thus, the phrases “in one embodiment”, “in an embodiment,” and similar language throughout this specification may, but do not necessarily, all refer to the same embodiment.

Furthermore, the described features, advantages, and characteristics of the present disclosure may be combined in any suitable manner in one or more embodiments. One skilled in the relevant art will recognize, in light of the description herein, that the present disclosure may be practiced without one or more of the specific features or advantages of a particular embodiment. In other instances, additional features and advantages may be recognized in certain embodiments that may not be present in all embodiments of the present disclosure.

Embodiments of the present disclosure are directed to a novel framework called “Restorative Speech Enhancement” (RestSE), which combines a lightweight SE module with a generative codec module to progressively enhance and restore speech signals. The embodiments separate the SE process into two distinct stages-de-noising and dereverberation—to improve overall speech quality.

The embodiments of the present disclosure provide a progressive learning pipeline. The proposed framework introduces a two-stage pipeline for SE. The first stage may focus on de-noising, employing a lightweight SE module to suppress environmental noise. The second stage may focus on dereverberation, leveraging a generative codec module to remove reverberation effects and restore speech naturalness.

The embodiments of the present disclosure provide optimization of quantization techniques. To further improve performance, the embodiments include quantization techniques within the codec module, such as, but not limited to, scalar quantization (SQ) and vector quantization (VQ). In one or more examples, SQ may first be applied, sequentially followed by VQ, resulting in superior restoration quality by capturing both coarse and fine details in the speech signal.

The embodiments of the present disclosure provide weighted loss function and feature fusion. In one or more examples, a weighted loss function is introduced, along with a feature fusion technique that merges the SE output with the original noisy mixture. This ensures robust restoration while preserving critical speech characteristics and minimizing distortions.

Accordingly, the embodiments of the present disclosure provide the following key contributions: (1) a progressive pipeline that separates de-noising and dereverberation, with each stage optimized for its specific task; (2) a novel quantization technique combining SQ and residual VQ for improved speech restoration; and (3) a loss function and feature fusion strategy that enhances overall performance by maintaining high fidelity to the original speech signal.

The proposed RestSE framework provides an effective solution for joint speech enhancement and dereverberation, significantly improving speech quality in noisy and reverberant environments. This method is particularly applicable in fields like telecommunications, voice-controlled systems, and hearing assistance devices, where clear and natural-sounding speech is crucial.

The embodiments of the present disclosure addresses challenges in improving the intelligibility and quality of speech in environments with noise and reverberation, particularly for applications such as telecommunications, voice-controlled systems, hearing aids, and audio recording devices. More specifically, the embodiments of the present disclosure provide a novel approach to jointly enhancing speech signals and reducing reverberation effects to ensure clear, natural-sounding speech output in adverse acoustic environments.

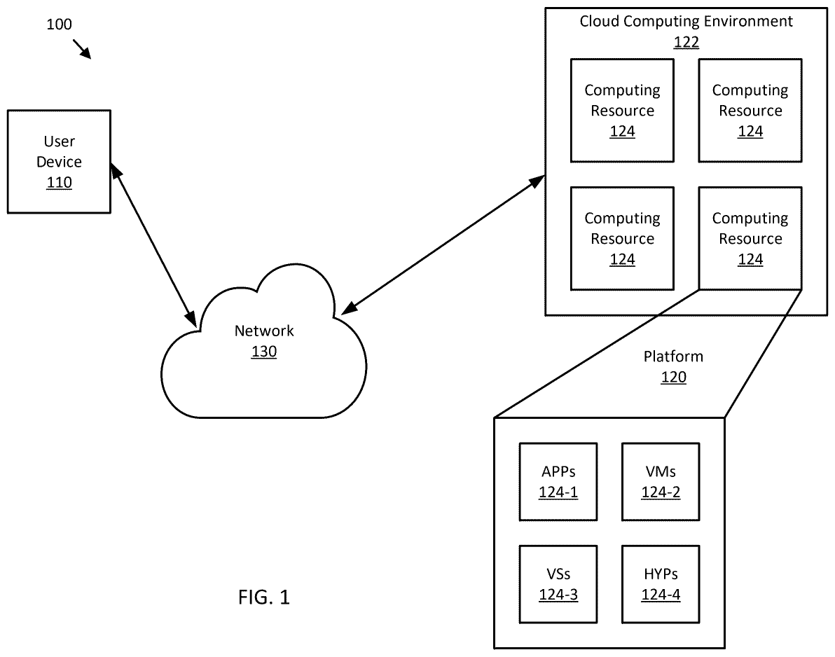

FIG. 1 is a diagram of an environment 100 in which methods, apparatuses, and systems described herein may be implemented, according to embodiments. As shown in FIG. 1, the environment 100 may include a user device 110, a platform 120, and a network 130. Devices of the environment 100 may interconnect via wired connections, wireless connections, or a combination of wired and wireless connections.

The user device 110 includes one or more devices capable of receiving, generating, storing, processing, and/or providing information associated with platform 120. For example, the user device 110 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, the user device 110 may receive information from and/or transmit information to the platform 120.

The platform 120 includes one or more devices as described elsewhere herein. In some implementations, the platform 120 may include a cloud server or a group of cloud servers. In some implementations, the platform 120 may be designed to be modular such that software components may be swapped in or out depending on a particular need. As such, the platform 120 may be easily and/or quickly reconfigured for different uses.

In some implementations, as shown, the platform 120 may be hosted in a cloud computing environment 122. Notably, while implementations described herein describe the platform 120 as being hosted in the cloud computing environment 122, in some implementations, the platform 120 may not be cloud-based (i.e., may be implemented outside of a cloud computing environment) or may be partially cloud-based.

The cloud computing environment 122 includes an environment that hosts the platform 120. The cloud computing environment 122 may provide computation, software, data access, storage, etc. services that do not require end-user (e.g. the user device 110) knowledge of a physical location and configuration of system(s) and/or device(s) that hosts the platform 120. As shown, the cloud computing environment 122 may include a group of computing resources 124 (referred to collectively as “computing resources 124” and individually as “computing resource 124”).

The computing resource 124 includes one or more personal computers, workstation computers, server devices, or other types of computation and/or communication devices. In some implementations, the computing resource 124 may host the platform 120. The cloud resources may include compute instances executing in the computing resource 124, storage devices provided in the computing resource 124, data transfer devices provided by the computing resource 124, etc. In some implementations, the computing resource 124 may communicate with other computing resources 124 via wired connections, wireless connections, or a combination of wired and wireless connections.

As further shown in FIG. 1, the computing resource 124 includes a group of cloud resources, such as one or more applications (APPs) 124-1, one or more virtual machines (VMs) 124-2, virtualized storage (VSS) 124-3, one or more hypervisors (HYPs) 124-4, or the like.

The application 124-1 includes one or more software applications that may be provided to or accessed by the user device 110 and/or the platform 120. The application 124-1 may eliminate a need to install and execute the software applications on the user device 110. For example, the application 124-1 may include software associated with the platform 120 and/or any other software capable of being provided via the cloud computing environment 122. In some implementations, one application 124-1 may send/receive information to/from one or more other applications 124-1, via the virtual machine 124-2.

The virtual machine 124-2 includes a software implementation of a machine (e.g. a computer) that executes programs like a physical machine. The virtual machine 124-2 may be either a system virtual machine or a process virtual machine, depending upon use and degree of correspondence to any real machine by the virtual machine 124-2. A system virtual machine may provide a complete system platform that supports execution of a complete operating system (OS). A process virtual machine may execute a single program, and may support a single process. In some implementations, the virtual machine 124-2 may execute on behalf of a user (e.g. the user device 110), and may manage infrastructure of the cloud computing environment 122, such as data management, synchronization, or long-duration data transfers.

The virtualized storage 124-3 includes one or more storage systems and/or one or more devices that use virtualization techniques within the storage systems or devices of the computing resource 124. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

The hypervisor 124-4 may provide hardware virtualization techniques that allow multiple operating systems (e.g. “guest operating systems”) to execute concurrently on a host computer, such as the computing resource 124. The hypervisor 124-4 may present a virtual operating platform to the guest operating systems, and may manage the execution of the guest operating systems. Multiple instances of a variety of operating systems may share virtualized hardware resources.

The network 130 includes one or more wired and/or wireless networks. For example, the network 130 may include a cellular network (e.g. a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g. the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g. one or more devices) of the environment 100 may perform one or more functions described as being performed by another set of devices of the environment 100.

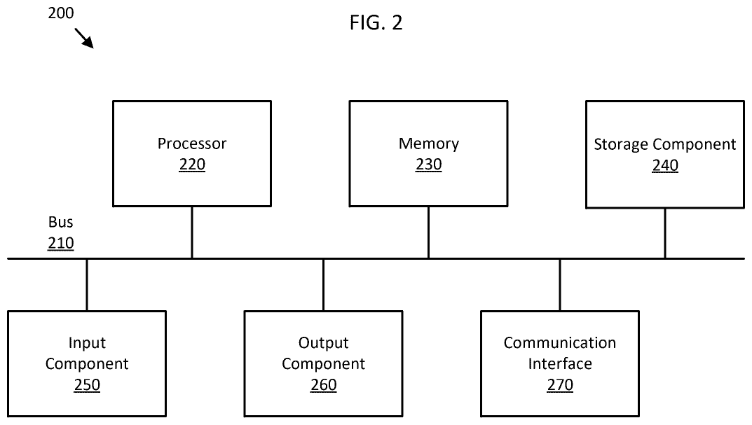

FIG. 2 is a block diagram of example components of one or more devices of FIG. 1. The device 200 may correspond to the user device 110 and/or the platform 120. As shown in FIG. 2, the device 200 may include a bus 210, a processor 220, a memory 230, a storage component 240, an input component 250, an output component 260, and a communication interface 270.

The bus 210 includes a component that permits communication among the components of the device 200. The processor 220 is implemented in hardware, firmware, or a combination of hardware and software. The processor 220 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, the processor 220 includes one or more processors capable of being programmed to perform a function. The memory 230 includes a random access memory (RAM), a read only memory (ROM), and/or another type of dynamic or static storage device (e.g. a flash memory, a magnetic memory, and/or an optical memory) that stores information and/or instructions for use by the processor 220.

The storage component 240 stores information and/or software related to the operation and use of the device 200. For example, the storage component 240 may include a hard disk (e.g. a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

The input component 250 includes a component that permits the device 200 to receive information, such as via user input (e.g. a touch screen display, a keyboard, a keypad, a mouse, a button, a switch, and/or a microphone). Additionally, or alternatively, the input component 250 may include a sensor for sensing information (e.g. a global positioning system (GPS) component, an accelerometer, a gyroscope, and/or an actuator). The output component 260 includes a component that provides output information from the device 200 (e.g. a display, a speaker, and/or one or more light-emitting diodes (LEDs)).

The communication interface 270 includes a transceiver-like component (e.g., a transceiver and/or a separate receiver and transmitter) that enables the device 200 to communicate with other devices, such as via a wired connection, a wireless connection, or a combination of wired and wireless connections. The communication interface 270 may permit the device 200 to receive information from another device and/or provide information to another device. For example, the communication interface 270 may include an Ethernet interface, an optical interface, a coaxial interface, an infrared interface, a radio frequency (RF) interface, a universal serial bus (USB) interface, a Wi-Fi interface, a cellular network interface, or the like.

The device 200 may perform one or more processes described herein. The device 200 may perform these processes in response to the processor 220 executing software instructions stored by a non-transitory computer-readable medium, such as the memory 230 and/or the storage component 240. A computer-readable medium is defined herein as a non-transitory memory device. A memory device includes memory space within a single physical storage device or memory space spread across multiple physical storage devices.

Software instructions may be read into the memory 230 and/or the storage component 240 from another computer-readable medium or from another device via the communication interface 270. When executed, software instructions stored in the memory 230 and/or the storage component 240 may cause the processor 220 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 2 are provided as an example. In practice, the device 200 may include additional components, fewer components, different components, or differently arranged components than those shown in FIG. 2. Additionally, or alternatively, a set of components (e.g. one or more components) of the device 200 may perform one or more functions described as being performed by another set of components of the device 200.

In one or more examples, the signals s(t), x(t), n(t) and h(t) represent the dry clean speech, reverberant speech, background noise, and a room impulse response (RIR) function, respectively. The noisy-reverberant mixture y(f) may be expressed as follows.

$$y ( t ) = x ( t ) + n ( t ) = s ( t ) * h ( t ) + n ( t ) , \qquad Eq . ( 1 )$$

where * denotes the convolution operator.

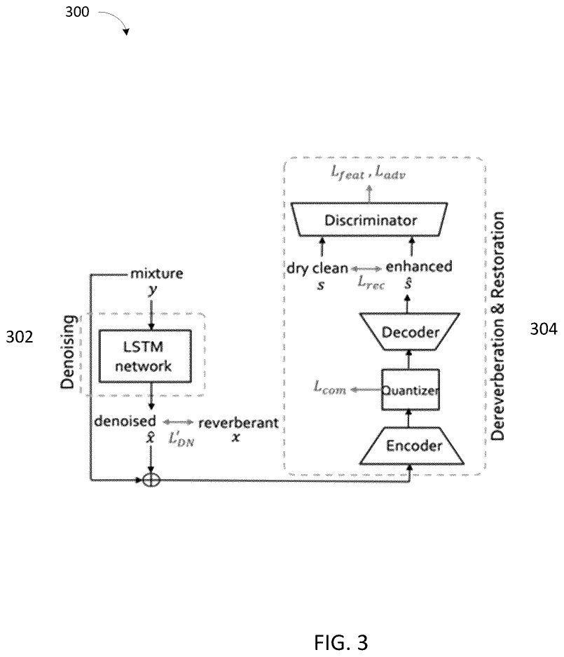

In one or more examples, the architecture 300 of the proposed RestSE approach is structured into a progressive pipeline with two sequential stages, as illustrated in FIG. 3. In one or more examples, the first stage, referred to as the de-noising (DN) stage 302, employs a lightweight SE module to reduce background noise only, with the target being the reverberant speech x. The second stage, termed the dereverberation and restoration (DR&RST) stage 302, utilizes a codec module to remove reverberation and restore the speech signal, ultimately aiming to recover the dry clean speech s. The motivation for using a progressive SE pipeline arises from the difficulty of a standalone SE module to handle both DN and DR effectively, as these tasks have different characteristics. Recent studies show that performing SE in the codec space reduces uncertainty and ambiguity in restoration. Based on this, the embodiments integrate a codec module in the DR&RST stage to improve speech restoration performance.

In one or more examples, to suppress noise, the T-F masking framework is employed with CRM estimated using a long-short term memory (LSTM) architecture. The LSTM network may include three hidden layers, each containing 300 units. The loss function may be calculated using a combination of a scale-invariant signal-to-distortion ratio (SI-SDR) loss in the time domain and a L₁ (e.g., least absolute deviations) loss on a spectrum magnitude difference between the denoised signal and the target reverberant signal as follows:

$${L}_{D N} = - S I - S D R ( \hat{x} , x ) + λ \cdot {L}_{1} ( \vert \hat{X} \vert , \vert X \vert ) , \qquad Eq . ( 2 )$$

where λ is set to 1000 to balance the value range of the two losses, with |\hat{X}| and |X| representing the magnitudes of the denoised signal and the target reverberant signal, respectively.

In one or more examples, the LSTM network is pre-trained using this loss function and then jointly trained with the codec module.

In one or more examples, a codec module may be used for dereverberation and speech restoration. These codec modules may include an encoder, a quantizer, and a decoder.

The embodiments may use the same SEANet architectures as SoundStream and Encodec for the encoder and the decoder. The encoder and decoder may be initialized with a pre-trained SoundStream model. In one or more examples, the encoder and decoder are kept fixed, where the quantization techniques may be varied.

According to one or more embodiments, quantization may include, but not limited, SQ and VQ. In one or more examples, in the SQ method, each sample may be quantized independently, without considering correlations between different dimensions. This approach is advantageous due to its simplicity and lower computational complexity.

For example, the SQ module may quantize the output of the encoder, denoted as z ∈ R^{F×D}, where F represents the number of frames and D, set to 256, denotes the dimensionality of each vector. The quantization process maps the output into a fixed scalar space as follows:

$$𝓏 = tanh ( 𝓏 ) , \qquad Eq . ( 3 )$$

$$r = round ( 𝓏 \times K ) / K , \qquad Eq . ( 4 )$$

where K is a hyper-parameter that determines the scope of the scalar space, and M is set to 8.

The tanh function may be initially applied to compress the feature values into the range [−1, 1], and the round operation reduces the value of range into 2×M+1 different values. In contrast, VQ operates by matching an input vector to the closest entry in a codebook and is effective at compressing highly correlated data and achieving better reconstruction quality in audio codecs. However, VQ comes with increased complexity, particularly as the vector dimensions and the size of the codebook grow. Specifically, VQ learns a codebook of N vectors to encode each D-dimensional frame of the encoder output z, which is then mapped to a sequence of one-hot vectors with shape F×N, where N equals to 1024.

In one or more examples, residual VQ (RVQ), which recursively quantizes residuals using distinct codebooks after an initial quantization step, may be used. In one or more examples, a residual version of SQ, termed Residual SQ (RSQ), may be used. In one on or more examples, a hybrid strategy may be used. For example, a hybrid strategy may integrate SQ and RVQ in different configurations, including the sequential application of SQ followed by RVQ (SQ-RVQ), a grouped configuration of SQ-RVQ, and a parallel configuration where SQ and RVQ are combined through a weighted sum (SQ ∥ RVQ). In one or more examples, the number of quantization modules Nq is fixed at 8 across all residual-based methods (i.e., RSQ, RVQ, and SQ-RVQ).

According to one or more embodiments, the training loss may include four parts: (1) reconstruction loss, L_{rec}, which utilizes multi-resolution STFT loss across both full-band and sub-band scales; (2) adversarial loss, L_{adv}, computed using hinge loss based on multi-scale STFT discriminators; (3) L_{feat}, applying the L₁ feature loss; and (4) commitment loss, L_{com}, applied between the output of the encoder, and its quantized representation. The respective weightings for these losses are set to 1 for both the reconstruction and adversarial losses, 20 for the feature loss, and 10 for the commitment loss.

In one or more examples, the DN stage not only reduces noise, but may also suppresses crucial speech content within the mixture, posing a challenge for the codec model in the DR stage to fully recover the enhanced speech due to the loss of essential information before it reaches the codec input. To address this issue, the embodiments of the present disclosure introduce a weighted loss function for the LSTM network and apply feature fusion that merges the denoised speech with the original mixture. The result of the fusion is then used as input for the codec to compensate for the missing information in the enhanced speech.

The embodiments may use a weighted loss function that emphasizes regions where the speech signal might be overly suppressed. The weighting factor α may be obtained as:

$$α = 1 + \frac{\vert Δ X \vert}{max ( \vert Δ X \vert )} \cdot M , \qquad Eq . ( 5 )$$

where M is a binary mask that applies the weight selectively to regions where the reference magnitude X exceeds a small predefined threshold (e.g., 1×10⁻⁸).

This threshold ensures that the weighting factor α only influences significant spectral components, preventing unnecessary emphasis on low-energy regions. ΔX′ is defined as:

$$Δ {X}^{′} = \{ \begin{matrix}2 \cdot Δ X & if Δ X < 0 \\ Δ X & otherwise\end{matrix} , \qquad Eq . ( 6 )$$

with ΔX=|\hat{X}|−|X| denoting the difference between the denoised spectrum magnitude |\hat{X}| and the reverberant spectrum magnitude |X|.

Finally, this weighting factor α may be integrated into the L₁ loss term in Eq. (2), resulting in the following modified loss function:

$${L}_{D N} = - S I - S D R ( \hat{x} , x ) + λ \cdot α \cdot {L}_{1} ( \vert \hat{X} \vert , \vert X \vert ) \qquad Eq . ( 7 )$$

Through these features, the weighted loss doubles the weight of the negative differences, thereby prioritizing regions where the speech components might have been overly suppressed.

In one or more examples, noisy spectral features may be combined with enhanced ones, leveraging clean speech data from the enhanced features while capturing complementary details from the noisy features. Building on this strategy, the embodiments include a feature fusion strategy that utilizes a linear layer to process both denoised speech and the mixture's magnitudes to create a unified representation. The fused feature may be fed to the codec module for further enhancement. Incorporating the mixture allows for the preservation of fine structures from the noisy features, thereby reducing over-suppression and improving speech restoration.

The embodiments of the present disclosure propose RestSE-a progressive learning pipeline to enhance speech in noisy and reverberant environments. The embodiments achieve the following advantages. First, a progressive pipeline may be utilized where a lightweight SE module is employed to reduce noise while preserving reverberation, and a generative codec module for effective dereverberation may be utilized. Second, different quantization techniques may be used such as SQ-RVQ. Third, a weighted loss function and a feature fusion approach that merges the SE output with the original mixture to enhance speech restoration an ensure robust restoration may be utilized. The experimental results demonstrate improvements across objective metrics, highlighting RestSE's potential for challenging speech enhancement tasks.

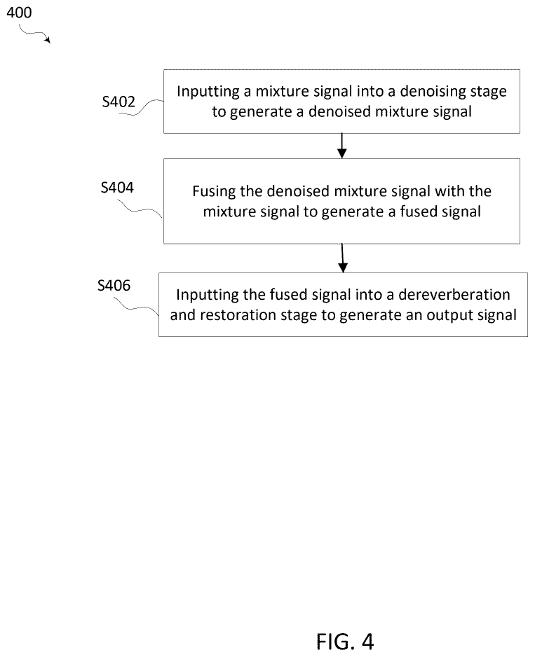

FIG. 4 illustrates a flowchart of an example process 400 for speech restoration enhancement. The process 400 may be implemented by processor 220 (FIG. 2). The process may start at operation S402 where an input mixture signal is input into a de-noising stage to generate a denoised mixture signal. For example, the mixture signal y(t) may be input into the de-noising stage 302 to generate the denoised mixture signal. The process proceeds to operation S404 where the denoised mixture signal is fused with the mixture signal to generate a fused signal. The process proceeds to operation S406 where the fused signal is input into a—dereverberation and restoration stage to generate an output signal. For example, the fused signal may be input into DR 304 to generate the output signal. The proposed methods disclosed herein may be implemented by processing circuitry (e.g., one or more processors or one or more integrated circuits). In one example, the one or more processors execute a program that is stored in a non-transitory computer-readable medium to perform one or more of the proposed methods.

The techniques described above may be implemented as computer software using computer-readable instructions and physically stored in one or more computer-readable media.

Embodiments of the present disclosure may be used separately or combined in any order. Further, each of the embodiments (and methods thereof) may be implemented by processing circuitry (e.g., one or more processors or one or more integrated circuits). In one example, the one or more processors execute a program that is stored in a non-transitory computer-readable medium.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, or a combination of hardware and software.

Even though combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having.” or the like are intended to be open-ended terms. Further, the phrase “based on” is intended to mean “based, at least in part, on” unless explicitly stated otherwise.

What is claimed is:

1. A method performed by at least one processor, the method comprising:
inputting a mixture signal comprising speech, background noise, and reverberation into a denoising stage that generates a denoised mixture signal with reduced noise compared to the mixture signal;
fusing the denoised mixture signal with the mixture signal to generate a fused signal; and
inputting the fused signal into a dereverberation and restoration (DR) stage to generate an output signal with reduced reverberation compared to the mixture signal.

2. The method according to claim 1, wherein inputting the mixture signal into the denoising stage further comprises:
inputting the mixture signal into a long short-term memory (LSTM) neural network that generates the denoised mixture signal.

3. The method according to claim 2, wherein the LSTM is pre-trained in accordance with a loss function determined in accordance with (i) a scale-invariant signal-to-distortion ratio (SI-SDR) of the denoised mixture signal and a target reverberant signal and (ii) a determined loss on a spectrum magnitude difference between the denoised mixture signal and the target reverberant signal.

4. The method according to claim 3, wherein the loss function is weighted in accordance with a scaling factor determined in accordance whether the spectrum magnitude difference is less than zero.

5. The method according to claim 3, wherein the pre-trained LSTM is jointly trained with the DR stage.

6. The method according to claim 1, wherein the inputting the fused signal into the DR stage further comprises:
inputting the fused signal into an encoder to generate an encoded fused signal;
inputting the encoded fused signal into a quantizer to generate a quantized signal; and
inputting the quantized signal into a decoder to generate the output signal.

7. The method according to claim 6, wherein the quantizer quantizes the encoded fused signal in accordance with scalar quantization.

8. The method according to claim 6, wherein the quantizer quantizes the encoded fused signal in accordance with vector quantization.

9. The method according to claim 5, wherein the quantizer quantizes the encoded fused signal in accordance with a combination of scalar quantization and vector quantization.

10. The method according to claim 6, wherein the DR stage is trained in accordance with a (i) a first loss between a target output signal and the output signal, (ii) a second loss using a hinge loss based on one or more multi-scale short-time Fourier transform (STFT) discriminators, (iii) a third loss in accordance with an L₁ feature loss, and (iv) a loss between the quantized signal and the encoded fused signal.

11. An apparatus comprising:
at least one memory configured to store program code; and
at least one processor configured to read the program code and operate as instructed by the program code, the program code including:
first inputting code configured to cause the at least one processor to input a mixture signal comprising speech, background noise, and reverberation into a denoising stage that generates a denoised mixture signal with reduced noise compared to the mixture signal;
fusing code configured to cause the at least one processor to fuse the denoised mixture signal with the mixture signal to generate a fused signal; and
second inputting code configured to cause the at least one processor to input the fused signal into a dereverberation and restoration (DR) stage to generate an output signal with reduced reverberation compared to the mixture signal.

12. The apparatus according to claim 11, wherein first inputting code further causes the at least one processor to:
input the mixture signal into a long short-term memory (LSTM) neural network that generates the denoised mixture signal.

13. The apparatus according to claim 12, wherein the LSTM is pre-trained in accordance with a loss function determined in accordance with (i) a scale-invariant signal-to-distortion ratio (SI-SDR) of the denoised mixture signal and a target reverberant signal and (ii) a determined loss on a spectrum magnitude difference between the denoised mixture signal and the target reverberant signal.

14. The apparatus according to claim 13, wherein the loss function is weighted in accordance with a scaling factor determined in accordance whether the spectrum magnitude difference is less than zero.

15. The apparatus according to claim 13, wherein the pre-trained LSTM is jointly trained with the DR stage.

16. The apparatus according to claim 11, wherein the second inputting code further causes the at least one processor to:
input the fused signal into an encoder to generate an encoded fused signal;
input the encoded fused signal into a quantizer to generate a quantized signal; and
input the quantized signal into a decoder to generate the output signal.

17. The apparatus according to claim 16, wherein the quantizer quantizes the encoded fused signal in accordance with scalar quantization.

18. The apparatus according to claim 16, wherein the quantizer quantizes the encoded fused signal in accordance with vector quantization.

19. The apparatus according to claim 15, wherein the quantizer quantizes the encoded fused signal in accordance with a combination of scalar quantization and vector quantization.

20. A non-transitory computer readable medium having instructions stored therein, which when executed by a processor cause the processor to execute a method comprising:
inputting a mixture signal comprising speech, background noise, and reverberation into a denoising stage that generates a denoised mixture signal with reduced noise compared to the mixture signal;
fusing the denoised mixture signal with the mixture signal to generate a fused signal; and
inputting the fused signal into a dereverberation and restoration (DR) stage to generate an output signal with reduced reverberation compared to the mixture signal.
